(19) United States
(12) Patent Application Publication
(10) Pub. No.: US 2012/0021290 A1
(43) Pub. Date: Jan. 26, 2012

(54) ELECTRIC POWER STORAGE SYSTEM

(76) Inventor: Chun-Yi HONG, Suao Town (TW)

(21) Appl. No.: 12/840,805

(22) Filed: Jul. 21, 2010

(51) Int. Cl. H01M 4/52; H01M 4/56; H01M 4/58

(52) U.S. Cl. 429/221; 429/231.95; 429/225; 429/122

(57) ABSTRACT

An electric power storage system, having application in energy systems, is primarily assembled from an electric power storage device and an electric power management system. In which, the electric power storage device is assembled from a first electric storage unit, a second electric storage unit and a super capacitance. Characteristics of the super capacitance are used to effect an electrical connection between the first electric storage unit and the second electric storage unit. The electric power management system is then used to implement management of energy resources. The present invention primarily uses the battery characteristics of lead acid batteries and lithium batteries (or lithium iron batteries) and management by the electric power management system to increase endurance and electric storage capacity the battery storage devices. The present invention further uses the characteristics of the super capacitance to enable the electric power storage system to implement momentary charging and discharging.

### BACKGROUND OF THE INVENTION

(a) Field of the Invention

The present invention relates to an electric power storage system, which can be applied in an energy system, and more particularly to an electric power storage system which integrates a diverse range of electric storage units, and uses an electric power management system to implement control measures, thereby achieving increasing electric storage capacity and endurance, as well as implementing momentary charging and discharging.

(b) Description of the Prior Art

The gain in ground of environmental protection awareness, and rising and development of green energy industries has brought about the continued appearance of all kinds of products in the market emphasizing high efficiency and environmental protection, thus, implementing effective management of a power source is the trend for future industrial development. Taking an electric storage unit as an example, from the former disposable electric storage units, reusable electric storage units were gradually developed, and general electric power storage systems primarily use a single electric storage unit to serve as the medium for storing electric energy, such as a lead acid battery or a lithium battery. Furthermore, although using a single electric storage unit can prevent conflict from occurring between one electric storage unit and another electric storage unit of different characteristics, thus, application use is restricted to the characteristics of the electric storage units used. Taking lead acid batteries as an example, they are provided with the advantages of having a simple structure, are low in price, and electromotive force is large, however, multiple recycling use cannot be implemented; whereas lithium batteries are provided with the advantages of having high storage density and are capable of multiple recycling use, however, production costs are expensive, preventing widespread use in large electric power locations. When a single electric storage unit is used, the working voltage thereof is subject to the limitations of the electric storage unit, and thus cannot be increased. Moreover, in a low voltage working environment, because of the characteristics of a portion of the electric storage units, thus, the serviceable life thereof is reduced. Furthermore, momentary charging and discharging cannot be effected for general electric storage units, and a momentary large voltage can possibly cause damage to the electric storage units, thereby preventing possible extension of the application field for electric power storage systems. In conclusion, the largest issue inhibiting the further development of electric power storage systems is in how to use the characteristics of different electric storage units to increase endurance of the electric power storage system.

### SUMMARY OF THE INVENTION

In view of the aforementioned problems, the primary objective of the present invention lies in providing an electric power storage system which integrates a diverse range of electric storage units, and functions in coordination with an electric power management system to increase electric storage capacity and endurance.

In order to achieve the aforementioned objective, an electric power storage system described in the present invention is primarily assembled from an electric power storage device and an electric power management system. In which, the electric power storage device is assembled from a first electric storage unit, a second electric storage unit and a super capacitance. Characteristics of the super capacitance are used to enable integration of the first electric storage unit and the second electric storage unit, and the electric power management system is used to manage electric storage capacity. Accordingly, assembly of each of the aforementioned components is used to increase endurance and electric storage capacity of the electric power storage system. Furthermore, the present invention further uses component characteristics of the super capacitance member to enable the electric power storage system to implement momentary charging and discharging. Hence, the electric power storage system can be applied in intermittent green energy systems.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a composition diagram depicting the units of the present invention.

FIG. 2 depicts another embodiment of the present invention.

FIG. 3 is an implementation schematic view of the present invention.

FIG. 4 is implementation schematic flow chart of the present invention.

### DETAILED DESCRIPTION OF THE PREFERRED EMBODIMENTS

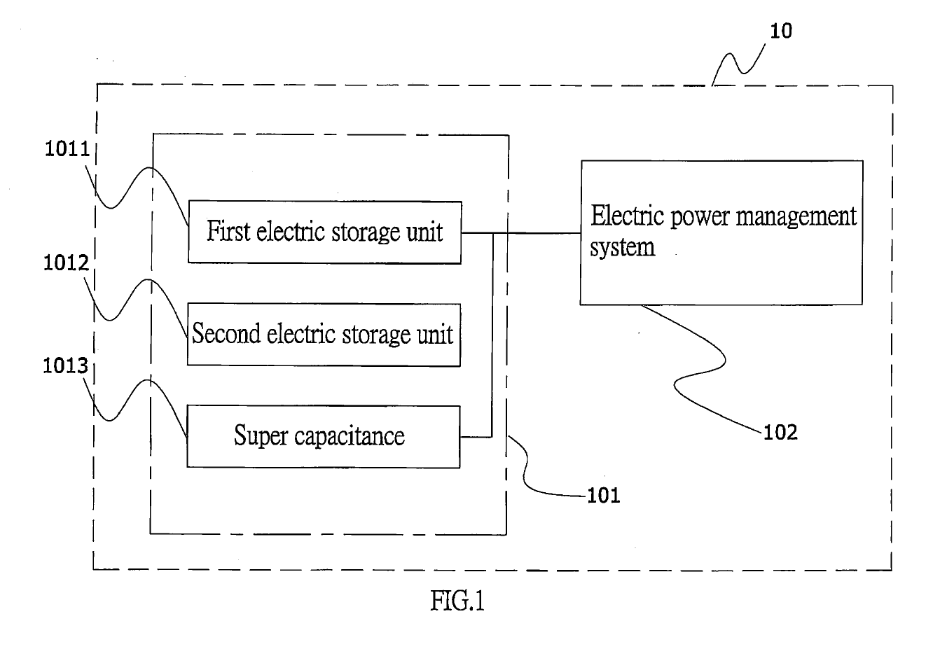

Referring to FIG. 1, which shows a composition diagram of units according to the present invention, and as depicted in the drawing, an electric power storage system 10 described in the present invention is primarily assembled from an electric power storage device 101 and an electric power management system 102, wherein the electric power storage device 101 is assembled from more than one first electric storage unit 1011, a plurality of second electric storage units 1012 and a super capacitance 1013. The first electric storage units 1011 can be lead acid batteries, and the second electric storage units 1012 can be lithium batteries or lithium iron batteries. Moreover, because the working voltage of the two electric storage units (1011, 1012) is different, thus, different numbers of the electric storage units (1011, 1012) can be connected in series according to the working voltage required to be achieved, thereby enabling the working voltages of the two electric storage units (1011, 1012) to achieve a balance. In addition, the second electric storage unit 1012 is electrically connected to the first electric storage unit 1011 through the super capacitance 1013, thereby enabling the first electric storage unit 1011 to be in a parallel connection state with the second electric storage unit 1012. Furthermore, the electric power management system 102 can be assembled in the form of an electronic substrate or coordinated functioning of a plurality of electrical switching elements, and is primarily assembled from an electric power management unit, an electric power detecting unit and an electric power converter unit. Moreover, the electric power management system 102 is electrically connected to the electric power storage device 101. In addition, the electric power management system 102 primarily controls electric power storage and electric power supply of the electric power storage system 10. In order to prevent excessive variation in the electric power peak value causing damage to the electric power management system, the components selected for the electric power management system 102 must be able to withstand the surge voltage. The aforementioned described super capacitance can be a super battery or a component provided with similar characteristics.

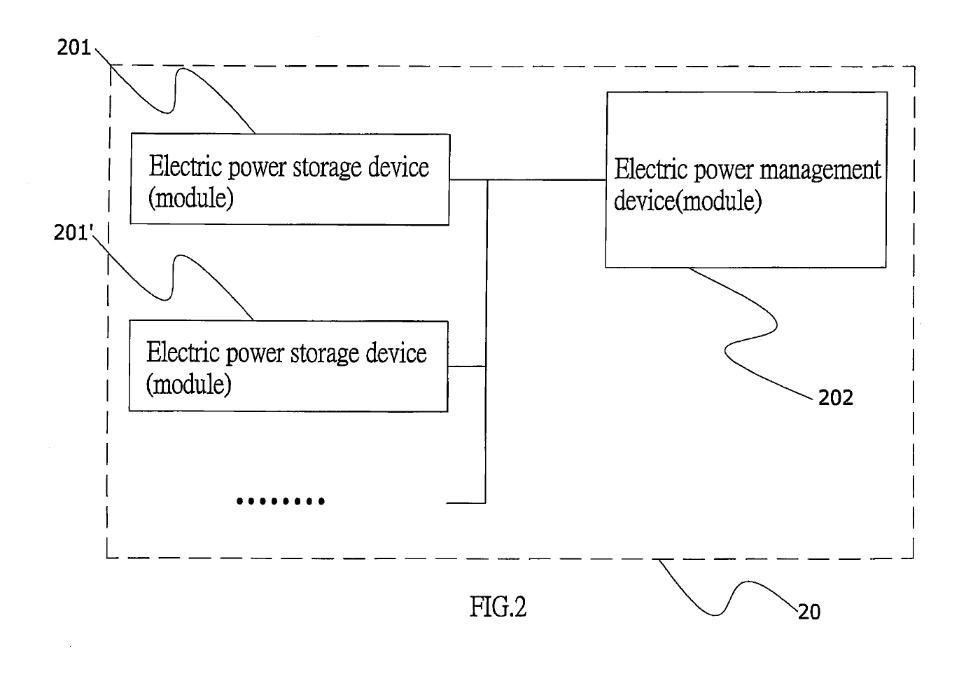

Referring to FIG. 2, which shows another embodiment of the present invention, and as depicted in the drawing, the electric power storage system 20 described in the present invention can further be assembled with a plurality of sets of electric power storage devices (201, 201′, . . . ) according to needs, and each of the electric power storage devices (201, 201′, . . . ) are separately electrically connected to an electric power management device 202. Accordingly, the electric power storage system 20 is able to use the electric power management device 202 to further control electric power of each of the electric power storage devices 201.

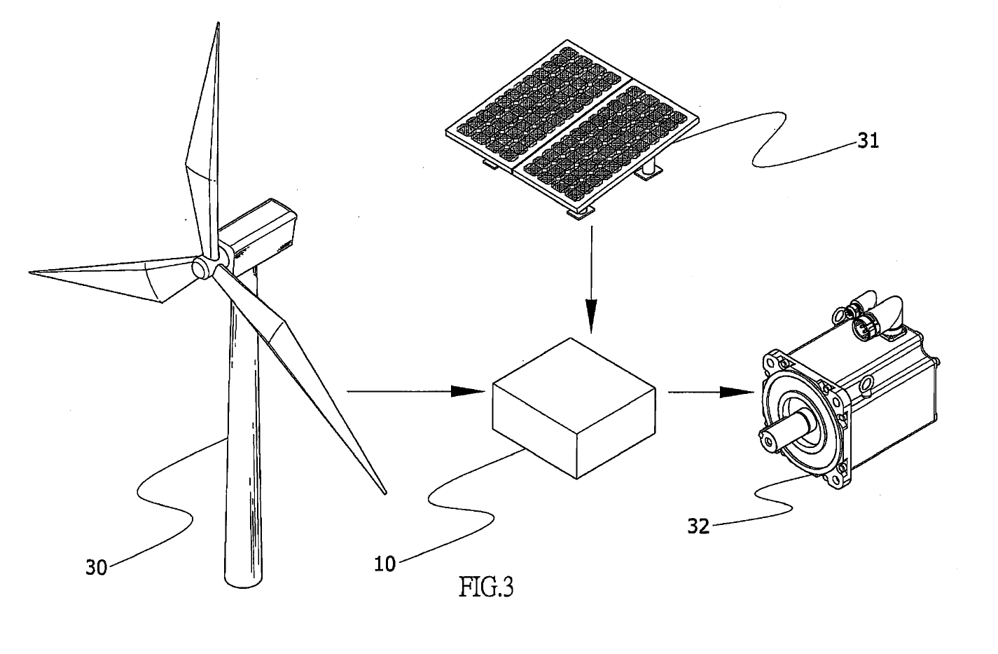

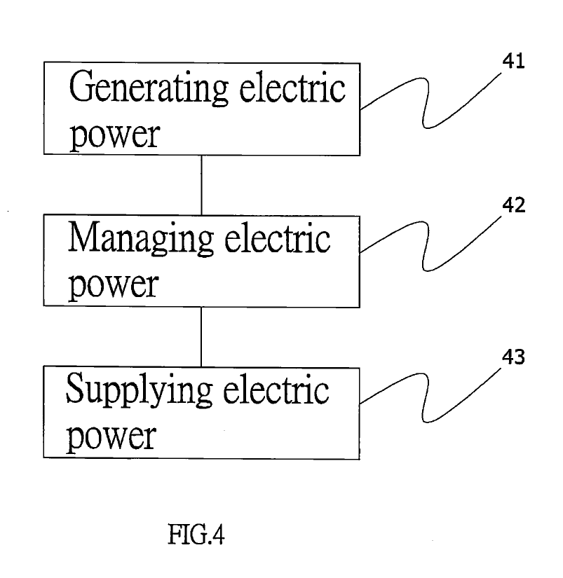

Referring to FIG. 3, which shows an implementation schematic view of the present invention, and the electric power storage system 10 described in the present invention can be applied in an energy system, which can be a wind power generation system 30 or a solar energy power generation system 31. Using a wind power generation system as an example for description, as depicted in the drawing, the wind power generation system 30 is electrically connected to the electric power storage system 10. When the wind power generation system 30 is generating electric power, then the electric power storage system 10 can be used to effect a storage operation, and the electric power storage system 10 can be electrically connected to a load end 32. In conjunction with FIG. 2 and FIG. 4, which shows an implementation schematic flow chart according to the present invention, as depicted in the drawings, the implementation flow of the present invention is as described below:

Generating electric power 41: When the wind power generation system 30 is propelled by wind, then driving of an internal generator thereof generates electric power, and the electric energy is stored in the electric power storage device 101 through the electric power management system 102.

Managing electric power 42: In a normal state, the electric power management system 102 implements detection of the quantity of electric power stored in the electric power storage device 101, and can further display the quantity of electric power stored on a panel.

Supplying electric power 43: When it is required for the load end 32 to operate, then the electric power management system 102 causes electric energy in the electric power storage device 101 to be supplied to the load end 32, while at the same time the electric power management system 102 is used to control and effect charging of the electric power storage device 101.

Based on the aforementioned, green energy resources, such as wind power generation, are all subject to outside influences, which affect the amount of electric energy generated. Taking wind power generation as an example, wind power generation is subject to the influences of the region where the wind power generation is set up and weather conditions influencing wind strength. When there is no wind, then no electric energy can be generated; on the contrary, when the wind is strong and sufficient to propel the wind power generation system, then electric energy can be generated. Nevertheless, because the electric energy generated by wind power is frequently large at one moment large, and small at another moment, thus, wear and tear of general electric storage components is accelerated. However, the present invention uses super capacitance to enable rapid charging and discharging, as well as having the characteristic of being able to absorb surge voltage. Hence, when electric power is unstable, the super capacitance is able to rapidly absorb and adjust surge voltage, thereby extending the service life of the electric power storage device. When the electric energy required by the load end suddenly increases, then the super capacitance can be used to rapidly supply electric energy, thereby enabling reducing the load which the two electric power storage units have to support.

In conclusion, the electric power storage system described in the present invention is primarily assembled from an electric power storage device and an electric power management system, in which the electric power storage device is assembled from a first electric storage unit, a second electric storage unit and a super capacitance. The characteristics of the super capacitance are used to effect an electrical connection between two electric storage components, and enable carrying out rapid charging and discharging operations. The present invention combines two different electric storage unit characteristics to increase electric storage capacity and endurance of the electric power storage device. The present invention further uses the electric power management system to implement energy resource management of the electric power stored in the electric power storage device. Accordingly, after implementation, the present invention is assuredly able to achieve providing an electric power storage system able to increase electric storage capacity and endurance, as well as carry out momentary charging and discharging.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An electric power storage system, having application in an energy system, comprising:
an electric power storage device, assembled from a first electric storage unit, a second electric storage unit, and a super capacitance, wherein the second electric storage unit is electrically connected to the first electric storage unit through the super capacitance; and
an electric power management system, the electric power management system is electrically connected to the electric power storage device.

2. The electric power storage system according to claim 1, wherein the first electric storage unit is a lead acid battery.

3. The electric power storage system according to claim 1, wherein the second electric storage unit is a lithium battery.

4. The electric power storage system according to claim 1, wherein the second electric storage unit is a lithium iron battery.

5. The electric power storage system according to claim 3, wherein a plurality of lithium batteries are used.

6. The electric power storage system according to claim 1, wherein the super capacitance is a super battery.

7. The electric power storage system according to claim 1, wherein the electric power management system is in the form of an electronic substrate.

8. The electric power storage system according to claim 1, wherein the electric power management system is provided with an electric power management unit.

9. The electric power storage system according to claim 1, wherein the electric power management system is provided with an electric power detecting unit.

10. The electric power storage system according to claim 1, wherein the electric power management system is provided with an electric power converter unit.
